(19) United States
(12) Patent Application Publication
(10) Pub. No.: US 2011/0243737 A1
(43) Pub. Date: Oct. 6, 2011

(54) METHOD AND SYSTEM FOR SECURING LIGHTING PROTECTION CABLES IN A WIND TURBINE ROTOR BLADE

(75) Inventors: Eric Lee Bell, Greenville, SC (US); Richard Hardison, Greenville, SC (US)

(73) Assignee: GENERAL ELECTRIC COMPANY, Schenectady, NY (US)

(21) Appl. No.: 13/039,602

(22) Filed: Mar. 3, 2011

(51) Int. Cl. F03D 11/00; B23P 19/00

(52) U.S. Cl. 416/146 R; 29/700

(57) ABSTRACT

A plurality of lightning receptors are configured along either or both of the suction side and pressure side shell members of a wind turbine blade. At least one lightning protection cable is disposed within the internal cavity of the blade, with the receptors in electrical conductive contact with the lightning protection cable. A plurality of cable attachment devices are disposed and spaced apart along either or both of the shell members. The attachment devices include a base that is fixed to the respective shell member and a receiver configured on the base that engages and supports the lighting protection, wherein the plurality of attachment devices intermittently support the lightning protection cable within the internal cavity of the blade.

### FIELD OF THE INVENTION

The present subject matter relates generally to wind turbines, and more particularly to wind turbine rotor blades having a lightning protection system configured therewith.

### BACKGROUND OF THE INVENTION

Large commercial wind turbines are prone to lightning strikes and, in this regard, it is a common practice to provide the turbine blades with lightning receptors spaced along the longitudinal length of the blade so as to capture and conduct the strikes to ground. These receptors are typically connected to one or more cables that run internally within the blade and are in electrical conduction to ground through various components in the hub, nacelle, and tower. The conventional practice is to hand laminate or infuse the lightning protection cables in the suction or pressure side shell members during fabrication of the blade. This is a laborious and time intensive practice that adds significantly to the overall production costs of the blades.

Accordingly, a need exists for an improved method and system configuration for securing the lighting protection cables within the interior of a wind turbine blade.

### BRIEF DESCRIPTION OF THE INVENTION

Aspects and advantages of the invention will be set forth in part in the following description, or may be obvious from the description, or may be learned through practice of the invention.

In a particular embodiment, a wind turbine rotor blade has a root, a tip, and a pressure and suction side shell members that extend between the tip and root and defining an internal cavity. A plurality of any manner of suitable lightning receptors are configured along an exterior surface of either or both of the shell members. At least one lightning protection cable is disposed within the internal cavity of the blade, with the receptors configured in electrical conductive contact with the lightning protection cable. A plurality of cable attachment devices are disposed on and spaced apart along either or both of the shell members, depending on the number and location of the lightning protection cables. In a particular embodiment, the attachment devices have a base that is fixed to a respective shell member and a receiver configured on the base that supports the lighting protection cable. With this configuration, the plurality of attachment devices may support the lightning protection cable within the internal cavity without laminating or otherwise attaching the cables directly to the shell members.

The configuration of the attachment device base may vary. In one embodiment, the base is a post-like member with a flange at one end thereof that is affixed to the shell member, for example with mechanical fasteners, such as bolts. The flange may be bonded to the shell member in an alternative embodiment. In still another embodiment, the base has an end that is molded into the shell member during formation of the shell member.

The configuration of the receiver may also vary widely within the scope and spirit of the invention. For example, the receiver may be a loop member through which the lightning protection cable is disposed. The loop member may be a continuous closed member wherein the lightning protection cable is threaded through the loop member. Multiple loop members may be configured on a single base.

In an alternate embodiment, the loop member may include a hinged section that moves to an open position so that the lighting protection cable can be laid within the receiver prior to closing the hinged section.

The attachment devices are, in a particular embodiment, spaced apart and have the receivers at a sufficient height such that free lengths of the lightning protection cable between adjacent attachment devices are suspended above said shell member. However, in alternate embodiments, the receivers may be spaced just slightly above the shell member such that the free lengths of the lightning protection cable lie against the shell member between the adjacent attachment devices.

The present invention also encompasses various method embodiments for securing a lighting protection cable to a shell member of a wind turbine rotor blade. A plurality of attachment devices are fixed in a spaced-apart configuration to an interior surface of the shell member, with the attachment devices having a receiver at one end thereof. The lighting protection cable is engaged with the receivers such that the cable is intermittently supported by the plurality of receivers within the interior of the rotor blade.

The attachment devices may have a base, wherein the method includes fixing the base to the shell member by any suitable means, such as mechanical fasteners, bonding, molding, and the like. The base may have any desired height relative to the shell member surface.

In a particular embodiment, the attachment devices have a closed loop receiver, and the method includes threading the loop receivers onto the lightning protection cable prior to attaching the base to the shell member. In an alternate embodiment, the base is first affixed to the shell member, and the lightning protection cable is subsequently threaded through the loop receivers.

In still a further embodiment, the attachment devices have a base and a loop receiver with a hinged section that moves to an open position, and the method includes fixing the plurality of bases to the shell member in any desired pattern or spacing, laying the lighting protection cable into the open receivers, and closing the hinged sections of the loop receivers to secure the cable within the receivers.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a conventional wind turbine;

FIG. 2 is a cross-sectional view of a rotor blade with a plurality of lightning receptors and associated lightning protection cables;

FIG. 3 is a perspective view of an embodiment of a lightning cable attachment device;

FIG. 4 is a perspective view of an alternative embodiment of a lightning cable attachment device;

FIG. 5 is a front view of still another embodiment of a lightning cable attachment device in an open position of the receiver;

FIG. 6 is a front view of the attachment device of FIG. 5 with the receiver in a closed position; and

FIG. 7 is a front view of an alternative embodiment of an attachment device with multiple receivers.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

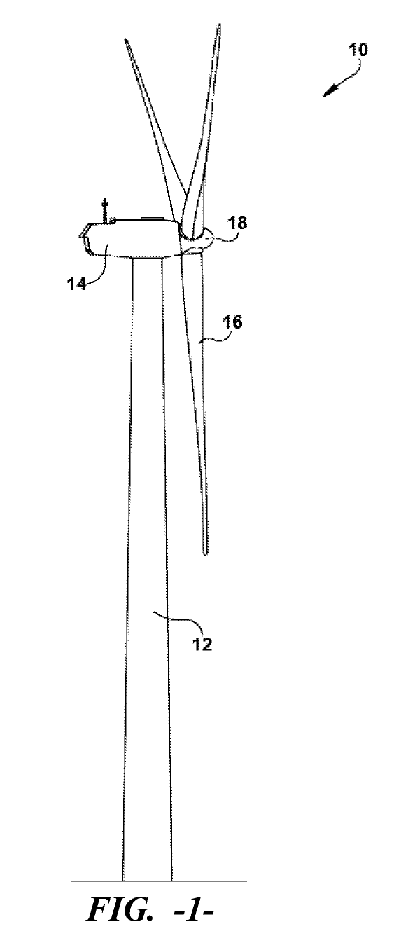

Referring to the drawings, FIG. 1 illustrates a perspective view of a horizontal axis wind turbine 10. It should be appreciated that the wind turbine 10 may be a vertical-axis wind turbine. In the illustrated embodiment, the wind turbine 10 includes a tower 12, a nacelle 14 mounted on the tower 12, and a rotor hub 18 that is coupled to the nacelle 14. The tower 12 may be fabricated from tubular steel or other suitable material. The rotor hub 18 includes rotor blades 16 coupled to and extending radially outward from the hub 18. As shown, the rotor hub 18 includes three rotor blades 16. However, in an alternative embodiment, the rotor hub 18 may include more or less than three rotor blades 16.

The rotor blades 16 may generally have any suitable length that enables the wind turbine 10 to function according to design criteria. The rotor blades 16 rotate the rotor hub 18 to enable kinetic energy to be transferred from the wind into usable mechanical energy, and subsequently, electrical energy. Specifically, the hub 18 may be rotatably coupled to an electric generator (not illustrated) positioned within the nacelle 14 for production of electrical energy.

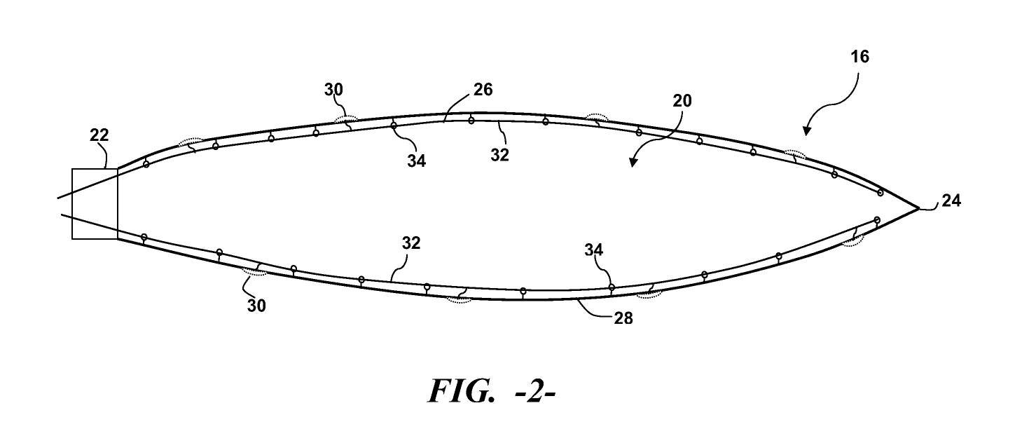

Referring to FIG. 2, a wind turbine rotor blade 16 is provided having a root 22, a tip 24, a pressure side shell member 26, and a suction side shell member 28. The shell members 26, 28 extend between the root 22 and tip 24 and define an internal cavity 20 for the blade 16. A plurality of lightning receptors 30 are configured along either or both of the pressure side shell member 26 or suction side shell member 28. For example, in the embodiment illustrated in FIG. 2, a plurality of the lightning receptors 30 are provided on each of the shell members 26, 28. In an alternative embodiment, the lightning receptors 30 may be provided on only one of the shell members 26, 28.

The lightning receptors 30 may be variously configured within the scope of the invention, and include any metal or metalized component (i.e., a metal screen, a metal rod or tip, and the like) mounted on the pressure or suction side shell members 26, 28 of the blade for the purpose of conducting lightning strikes to ground.

Still referring to FIG. 2, the blade 16 includes one or more lighting protection cables 32 disposed generally lengthwise within the internal cavity 20 of the blade 16. The lightning receptors 30 are connected to a respective cable 32 by a cable, wire, or other conductive means. In the illustrated embodiment, the receptors 30 on the pressure side shell member 26 are connected to a common cable 32, and the receptors 39 on the suction side shell member 26 are connected to a different respective cable 32. The lightning protection cables 32 include terminal ends that extend through the root portion 22 of the blade 16 and are individually connected to a grounding system within the rotor hub 18. The grounding system may be variously configured, as is well known in the art. For example, the grounding system may include any conductive path defined by the wind turbine's machinery or support structure, including blade bearings, machinery bed plates, tower structure, and the like, that defines a ground conductive path from the blade 16, through the tower 12, to a ground rod via a ground cable, or other suitable electrical ground path.

The lightening protection cables 32 are supported by a plurality of cable attachment devices 34 along the pressure or suction side shell members 26, 28. The attachment devices 34 are spaced apart along the length of the cable run so that the cable 32 is intermittently supported by the attachment devices 34 within the interior cavity 20 of the blade 16. Thus, the lightening protection cable 32 need not be laminated to, molded in, or otherwise permanently affixed to the shell members 26, 28.

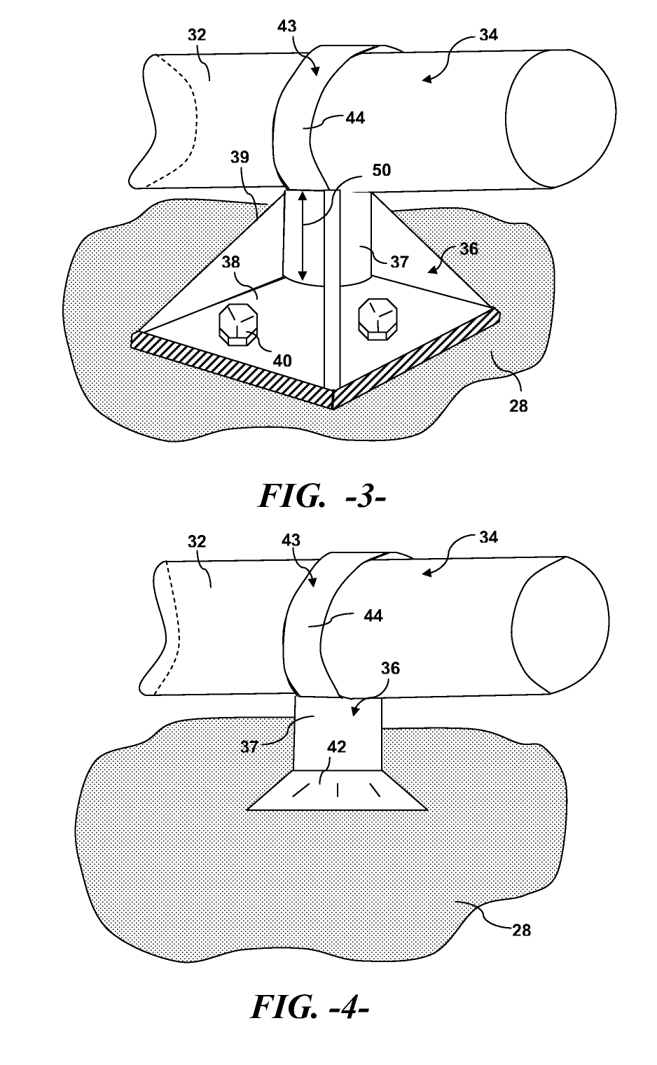

Various embodiments of the cable attachment devices 34 are illustrated in FIGS. 3 through 6. In general, the cable attachment devices 34 include a base 36 that is fixed to the respective shell member and a receiver 43 that is configured on the base 36 and has a shape and configuration for engaging and supporting the lightening protection cable 32. The term “base” is used herein to encompass any manner of structure that supports the receiver 43 relative to the respective shell member 26, 28. In the embodiment illustrated in FIG. 3, the base 36 includes a post member 37 configured on a flange 38. The flange 38 is mounted with any manner of suitable mechanical fastener 40, such as bolts, to the internal surface of the shell member 28 (which may also be the shell member 26).

In the embodiment of FIG. 4, the base 36 includes a generally cylindrical post member 37 that has one end thereof bonded or molded to the shell member 28 with any manner of suitable adhesive or bonding material 42. In this embodiment, a recess or hole may be defined in the shell member 28 at the desired location for the attachment device 34 for receipt of the post member 37 therein. A suitable epoxy or other bonding material 42 may then be formed around the base of the post and the recess in order to securely attach the base 36 to the shell member 28.

It should be readily appreciated that any manner of mechanical or adhesive/bonding method may be used to secure the base member 36 of the respective cable attachment devices 34 to the shell members at any desired location within the internal cavity 20 of the blade 16, and that the invention is not limited to any particular type of securement mechanism or method.

The receiver 43 may also vary widely within the scope and spirit of the invention. In the embodiments depicted in FIGS. 3 and 4, the receiver 43 is defined by a loop member 44 having a diameter that is particularly sized for sliding receipt of the lightening protection cable 32 therethrough. In the embodiments of FIGS. 3 and 4, the loop member 44 is a continuous closed member such that the cable 32 is threaded through the attachment devices 34 after the devices have been affixed to the shell members 26, 28 in a defined pattern.

In an alternate embodiment, the attachment devices 34 may be threaded onto the lightening protection cable 32, which is then laid out in the shell member 26, 28 along a desired cable run path. The attachments devices 34 may then be moved along the cable 32 to achieve a desired spacing of the attachment devices 34 prior to fixing the base members 36 to the respective shell member 26, 28. A mechanical fastening embodiment, such as the embodiment in FIG. 3, would be beneficial in this particular procedure.

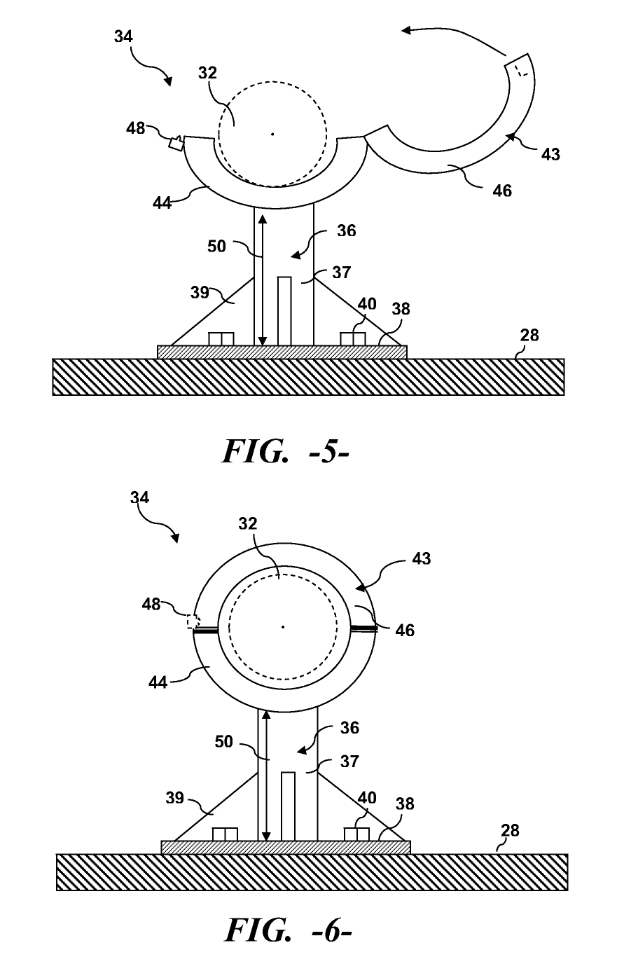

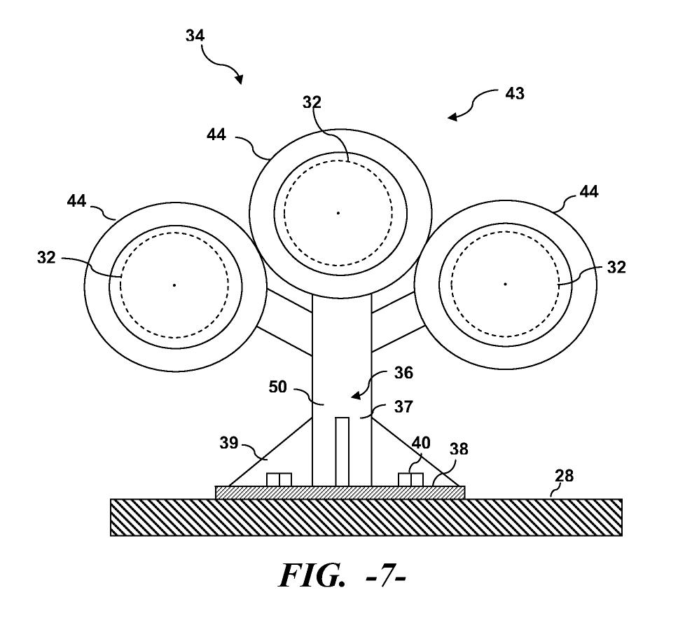

FIGS. 5 and 6 depict an alternative embodiment of the loop member 44 that defines the receiver 43. In this particular embodiment, the loop member 44 includes a hinged section 46 that opens to receive the cable 32 therein, as depicted in FIG. 5. Once the cable is laid within the bottom portion of the loop member 44, the hinge section 46 is closed and latched via any suitable latching mechanism 48. This particular embodiment may be desired in that it allows for the attachment devices 34 to be affixed to the shell member 26, 28 in a predetermined pattern, whereby the lightening protection cable 32 is subsequently rolled out adjacent to the attachment devices 34 and placed into the attachment devices as depicted in FIGS. 5 and 6. This configuration and method eliminates the tedious process of threading the cable 32 through the devices.

The embodiment of FIGS. 5 and 6 may also be desired in that the loop member 44 may be designed to have a snug or relatively close fit around the cable 32 to prevent sliding movement of the cable 32 within the loop member 44. The loop member 44 may include any manner of gasket material or other type of compressible seal for this purpose. This configuration may be desired in certain embodiments to prevent relative sliding movement of the cable 32 within the attachment devices 34. This function would not be possible with an embodiment of the receiver 43 wherein the cable 32 is threaded through the closed loop member 44, as in the embodiments of FIGS. 3 and 4.

Referring to FIGS. 3, 5, and 6, it should be appreciated that the component of the base member 36 that supports the receiver 43 above the shell members 26, 28 may have any desired relative stand-off height 50 relative to the shell member. For example, in a particular embodiment this stand-off height 50 may be sufficient such that the free length of the lightening protection cable 32 between adjacent attachment devices 34 are suspended above the shell member, as depicted in FIG. 2. In an alternate embodiment, the base member 36 may have relatively little stand-off height 50 such that the receiver 43 is essentially disposed on or slightly above the surface of the shell member 26, 28. In this embodiment, the free lengths of the lightening protection cable 32 would lie against the shell member.

Referring to FIG. 7, it should be appreciated that any number and pattern of receivers 43 may be configured on a single base 36, such as the plurality of loop members 44 depicted in FIG. 7. This embodiment may be desired when multiple cables 32 are run within the internal cavity of the wind turbine blade.

It should be appreciated that the invention also encompasses any manner or configuration of wind turbine 10 having blades 16 utilizing any one of the aspects or embodiments of the invention described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A wind turbine rotor blade, comprising:
a root, a tip, and a pressure side shell member and a suction side shell member extending between said tip and said root, said shell members defining an internal cavity;
a plurality of lightning receptors configured along either or both of said shell members;
at least one lightning protection cable disposed within said internal cavity, said receptors in electrical conductive contact with said lightning protection cable; and,
a plurality of cable attachment devices disposed on and spaced apart along either or both of said shell members, said attachment devices comprising a base that is fixed to said respective shell member and at least one receiver configured on said base that engages and supports the lighting protection cable;
wherein said plurality of attachment devices intermittently support the lightning protection cable within said internal cavity.

2. The wind turbine rotor blade as in claim 1, wherein said base comprises a flange at one end thereof that is affixed to said shell member.

3. The wind turbine rotor blade as in claim 1, wherein said base has an end that is bonded to or molded in said shell member.

4. The wind turbine rotor blade as in claim 1, wherein said receiver comprises a loop member through which the lightning protection cable is disposed.

5. The wind turbine rotor blade as in claim 4, wherein said loop member comprises a hinged section that moves to an open position so that the lighting protection cable can be laid within said receiver.

6. The wind turbine rotor blade as in claim 4, wherein said loop member comprises a closed member such that the lightning protection cable is threaded through said receiver.

7. The wind turbine rotor blade as in claim 1, wherein said attachment devices are spaced apart and said bases have a sufficient stand-off height relative to said shell member such that free lengths of the lightning protection cable between adjacent said attachment devices are suspended above said shell member.

8. The wind turbine blade as in claim 1, wherein a plurality of said receivers are configured on a single said base.

9. A method for securing a lighting protection cable to a shell member of a wind turbine rotor blade, comprising:
fixing a plurality of attachment devices in a spaced-apart configuration to an interior surface of the shell member, the attachment devices having a receiver at one end thereof; and
securing the lighting protection cable to the receivers such that the lighting protection cable is intermittently supported by the plurality of receivers and has free length sections between adjacent attachment devices.

10. The method as in claim 9, wherein the attachment devices have a base, and further comprising attaching the base to the shell member with mechanical fasteners.

11. The method as in claim 9, wherein the attachment devices have a closed loop receiver, and further comprising threading the loop receivers onto the lightning protection cable prior to attaching the base to the shell member.

12. The method as in claim 9, wherein the attachment devices have a loop receiver and a base, and further comprising bonding or molding the base to shell member and subsequently threading the lightning protection cable through the loop receivers.

13. The method as in claim 9, wherein the attachment devices have a base and a loop receiver with a hinged section that moves to an open position, and further comprising fixing the bases to the shell member, laying the lighting protection cable into the open receivers, and closing the hinged sections of the loop receivers.

14. The method as in claim 9, wherein the attachment devices have a base, and further comprising attaching the base to the shell member with a stand-off height such that the free length sections of the lightning protection cable are suspended above the shell member between adjacent attachment devices.
